(19) United States
(12) Patent Application Publication
(10) Pub. No.: US 2016/0343465 A1
(43) Pub. Date: Nov. 24, 2016

(54) ELECTRICAL INSULATION MATERIAL AND TRANSFORMER

(71) Applicant: 3M INNOVATIVE PROPERTIES COMPANY, Saint Paul, MN (US)

(72) Inventors: Robert H. Turpin, Hill, NH (US); Rhesa M. Browning, Austin, TX (US); David V. Mahoney, Austin, TX (US); Mitchell T. Huang, Austin, TX (US); David S. Stankes, Austin, TX (US); Martin H. Fox, Wiscasset, ME (US)

(21) Appl. No.: 15/113,943

(22) PCT Filed: Jan. 27, 2015
(86) PCT No.: PCT/US2015/012982

§ 371 Date: Jul. 25, 2016

Related U.S. Application Data
(60) Provisional application No. 61/931,792, filed on Jan. 27, 2014.

(51) Int. Cl. H01B 3/00; H01F 27/28; H01B 3/47; H01F 27/32; H01B 3/28; H01B 3/44

(52) U.S. Cl. CPC H01B 3/002; H01B 3/28; H01B 3/448; H01B 3/47; H01F 27/327; H01F 27/2876

(57) ABSTRACT

An article comprises an inorganic filler, fully hydrolyzed polyvinyl alcohol fibers, a polymer binder, and high surface area fibers. The article can be formed as an electrically insulating paper for electrical equipment, such as a liquid filled transformer, which can thereby be substantially cellulose free.

### TECHNICAL FIELD

This invention relates to materials suitable for electrical insulation applications. In particular, this invention relates to electrical insulation materials suitable for transformers, such as liquid filled transformers.

### BACKGROUND

Electrical equipment such as electric motors, generators, and transformers often require some form of dielectric insulation to isolate adjacent conductors. A conventional insulating material is Kraft paper, which is a cellulose-based material that is often utilized in liquid filled transformers.

However, cellulose paper suffers from several disadvantages such as high moisture absorption, water generation upon degradation, and limited thermal capabilities. Current liquid filled transformers require a moisture content of less than 0.5 wt % to operate reliably throughout its designed product lifetime. Water contamination in a liquid filled transformer results in reduced performance through increased electrical losses and electrical discharge activity. Because of its strong affinity for water (hygroscopic), cellulose paper forces liquid filled transformer manufacturers to spend extensive time and energy towards drying out these materials prior to final assembly into a liquid filled transformer. The presence of moisture can further accelerate cellulose degradation and results in additional release of water as a degradation product.

The other main shortcoming of cellulose paper is its limited thermal stability. Standard Kraft paper has a thermal class of 105° C. and thermally upgraded Kraft has a thermal class of 120° C. The maximum operating temperature of the liquid filled transformer insulated with Kraft paper is limited by the thermal capabilities of the Kraft paper.

### SUMMARY

There is a need in certain electrical insulation applications for materials with lower moisture absorption and higher thermal stability that achieve suitable performance in electrical equipment applications.

The materials of the present invention are suitable for insulating electrical components in transformers, motors, generators, and other devices requiring insulation of electrical components. In particular, such materials are suitable as insulation paper for liquid filled transformers and other liquid filled electrical components.

At least some embodiments of the present invention provide an insulation article having lower moisture absorption. At least some embodiments of the present invention provide an electrically insulating paper having desirable moisture absorption, thermal stability and thermal conductivity when compared to conventional cellulose-based Kraft paper.

At least one embodiment of the present invention provides an article comprising an inorganic filler, fully hydrolyzed polyvinyl alcohol fibers, a polymer binder, and high surface area fibers. In another aspect, the article is formed as a nonwoven paper.

In another aspect, the inorganic filler comprises at least one of kaolin clay, talc, mica, calcium carbonate, silica, alumina, alumina trihydrate, montmorillonite, smectite, bentonite, illite, chlorite, sepiolite, attapulgite, halloysite, vermiculite, laponite, rectorite, perlite, aluminum nitride, silicon carbide, boron nitride, and combinations thereof.

In another aspect, the inorganic filler comprises kaolin clay. In a further aspect, the kaolin clay comprises at least one of water-washed kaolin clay, delaminated kaolin clay, calcined kaolin clay, and surface-treated kaolin clay.

In another aspect, the polymer binder comprises a latex-based material. In a further aspect, the polymer binder comprises at least one of acrylic, nitrile, and styrene acrylic latex.

In another aspect, the high surface area fiber comprises a glass microfiber.

In another aspect, the article comprises from about 3% to about 20% fully hydrolyzed polyvinyl alcohol fibers. In a further aspect, the article comprises from about 50% to about 85% kaolin clay, from about 7% to about 25% polymer binder, and from about 2% to about 10% glass microfiber. The percentages are by weight.

In another aspect, the article is substantially cellulose free.

In another aspect, the article is non-hygroscopic.

Another embodiment of the present invention provides an insulation system for electrical equipment, wherein the insulation system comprises the aforementioned article. The electrical equipment comprises one of a transformer, a motor, and a generator. In one aspect, the electrical equipment comprises a liquid filled transformer.

Another embodiment of the present invention provides an oil filled transformer comprising electrical insulating paper having fully hydrolyzed polyvinyl alcohol fibers. In another aspect, the electrical insulating paper further comprises an inorganic filler, a polymer binder, and high surface area fibers. In a further aspect, the oil filled transformer comprises about 3% to about 20% fully hydrolyzed polyvinyl alcohol fibers, from about 50% to about 85% kaolin clay, from about 7% to about 25% polymer binder, and from about 2% to about 10% glass microfiber, wherein the percentages are by weight. In a further aspect, the electrical insulating paper is substantially cellulose free.

As used in this specification:

“substantially cellulose free” means containing less than 10 wt % cellulose-based material, preferably containing less than 5 wt % cellulose-based material, more preferably containing only trace amounts of cellulose-based material, and most preferably containing no cellulose-based material.

“non-hygroscopic” means containing less than 5 wt % water content at a relative humidity of 50%, more preferably containing less than 1.5 wt % water content at a relative humidity of 50%, and even more preferably less than 1 wt % water content at a relative humidity of 50%.

The above summary of the present invention is not intended to describe each disclosed embodiment or every implementation of the present invention. The detailed description that follows below more specifically illustrates embodiments of the invention.

### BRIEF DESCRIPTION OF THE DRAWINGS

The invention will be described hereinafter in part by reference to non-limiting examples thereof and with reference to the drawings, in which:

FIG. 1 is schematic diagram of an insulating system suitable for use in an electrical transformer according to an aspect of the invention.

FIG. 2 is a graph comparing drying times between insulating paper of according to an aspect of the invention and conventional Kraft paper.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following description, it is to be understood that other embodiments are contemplated and may be made without departing from the scope of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the present specification and attached claims are approximations that can vary depending upon the desired properties sought to be obtained by those skilled in the art utilizing the teachings disclosed herein. The use of numerical ranges by endpoints includes all numbers and any value within that range (e.g., 1 to 5 includes 1, 1.5, 2, 2.75, 3, 3.80, 4, and 5).

At least one embodiment of the present invention provides an article comprising an inorganic filler, fully hydrolyzed polyvinyl alcohol fibers, a polymer binder, and high surface area fibers. The article can be formed as an insulating paper for electrical equipment, such as transformers, motors, generators. Electrical equipment is sometimes filled with an insulating (dielectric) liquid or fluid. Typical fluids used in liquid filled electrical equipment can include mineral oil, natural ester oils, synthetic ester oils, silicone oils, and the like. The article can be formed as an insulating paper for liquid-filled electrical equipment, such as liquid filled transformers, liquid filled cable, and liquid filled switchgear. As a result, the insulating system, and the electrical equipment, can be substantially cellulose free.

At least some embodiments of the present invention provide an electrical insulation article having lower moisture absorption, higher thermal stability and higher thermal conductivity as compared to conventional cellulose-based Kraft paper.

Although cellulose-based Kraft paper has been used in the liquid filled transformer industry for many years, the high moisture absorption, susceptibility to hydrolysis, and limited high temperature capabilities are known disadvantages. By omitting cellulose and instead using fully hydrolyzed polyvinyl alcohol fibers, more particularly a combination of an inorganic filler, such as kaolin clay, and fully hydrolyzed polyvinyl alcohol fibers in the article, an electrically insulating paper with lower moisture absorption, better hydrolytic stability, higher thermal stability, and higher thermal conductivity has been demonstrated as compared to standard Kraft paper.

The article and electrically insulating paper for liquid filled transformers described herein can provide a transformer manufacturer with the ability to reduce current extensive time and energy-consuming dry out cycles that are typically performed to dry out a transformer unit insulated with traditional Kraft paper prior to oil impregnation. These dry out cycles may last from between 12 hours to several days depending on design and size of unit. Further, not only is Kraft cellulose paper hygroscopic, the aging and actual degradation of cellulose generates water as a by-product which can further reduce the insulation qualities of the transformer oil.

As mentioned above, the electrically insulating paper comprises polyvinyl alcohol (PVOH) fibers. In one example, the electrically insulating paper comprises from about 3% to about 20% fully hydrolyzed polyvinyl alcohol fibers by weight. By fully hydrolyzed, it is meant that the fibers contain less than 5% unhydrolyzed vinyl acetate units and therefore have a degree of hydrolysis of at least 95%. Fully hydrolyzed polyvinyl alcohol typically has a melting point of 230° C. More preferably, the fully hydrolyzed fibers possess high tenacity (>6 g/denier). Fully hydrolyzed, high tenacity polyvinyl alcohol fibers are typically insoluble in water at room temperature. Polyvinyl alcohol fibers with a low degree of hydrolysis are typically soluble in water at room temperature and are typically used as binder fibers. Partially hydrolyzed polyvinyl alcohol typically has a melting point ranging from 180-190° C.

In addition, the electrically insulating paper comprises an inorganic filler. In one aspect, suitable inorganic fillers include, but are not limited to, kaolin clay, talc, mica, calcium carbonate, silica, alumina, alumina trihydrate, montmorillonite, smectite, bentonite, illite, chlorite, sepiolite, attapulgite, halloysite, vermiculite, laponite, rectorite, perlite, aluminum nitride, silicon carbide, boron nitride, and combinations thereof. The inorganic filler may also be surface treated. Suitable types of kaolin clay include, but are not limited to, water-washed kaolin clay; delaminated kaolin clay; calcined kaolin clay; and surface-treated kaolin clay. In one example, the electrically insulating paper comprises from about 50% to about 85% kaolin clay by weight.

In addition, the electrically insulating paper comprises a polymer binder. A suitable polymer binder may include a latex-based material. In another aspect, suitable polymer binders can include, but are not limited to, acrylic, nitrile, styrene acrylic latex, guar gum, starch, and natural rubber latex. In one example, the electrically insulating paper comprises from about 7% to about 25% polymer binder by weight.

In addition, the electrically insulating paper comprises a high surface area fiber. In one example, the electrically insulating paper comprises glass microfiber. In one example, the electrically insulating paper comprises from about 2% to about 10% glass microfiber by weight. In this aspect, the high surface area fiber has an average diameter of about 0.6 μm or less. The high surface area fiber can be used to help drain the mixture through the paper formation process.

In many of the embodiments, the electrically insulating paper is formed as a nonwoven paper. In addition, the nonwoven paper may be formed from a standard paper process. For example, the elements of the formulation can be mixed as a slurry in water, pumped into a cylinder paper machine, formed into a sheet, then dried. The nonwoven paper may also be calendered to produce a high density paper.

The result is a nonwoven, non-hygroscopic insulating paper suitable for use in electrical equipment, such as for the insulation system within a liquid filled transformer. The electrically insulating paper is oil saturable.

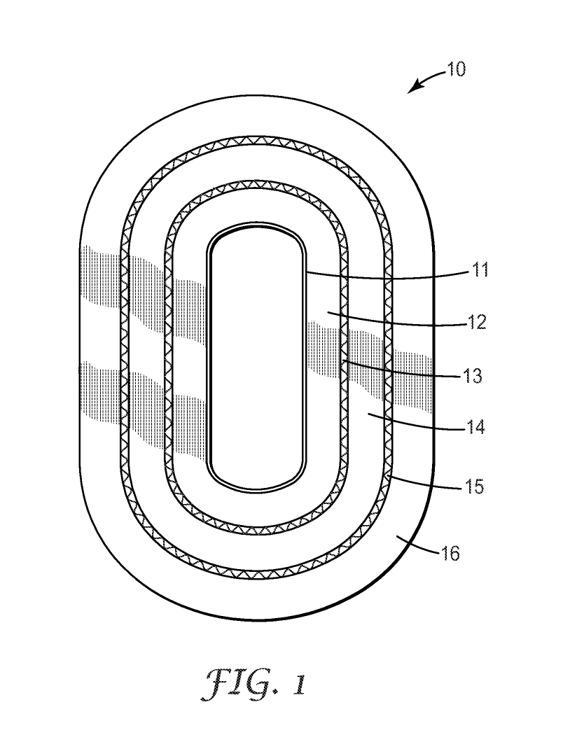

For example, FIG. 1 shows another aspect of the present invention, a diagram of an insulation system 10 for a liquid filled transformer. In one exemplary aspect, the transformer comprises an oil filled transformer. The insulation system 10 is shown as a winding for a transformer.

In one example implementation, a winding form 11 is provided in the center region of insulation system 10. The winding form may be formed as a thick board insulation formed from the electrically insulating paper described above. A first low voltage winding 12 surrounds the winding form 11. The winding 12 comprises one or more layers of wound conductor separated by layer insulation, e.g., one or more layers of insulating paper (such as the electrically insulating paper described above). A first interwinding insulation 13 is provided around the first low voltage winding 12 and can be formed from one or more layers of the electrically insulating paper described above. A first high voltage winding 14, comprising one or more layers of wound conductor separated by layer insulation, e.g., one or more layers of insulating paper (such as the electrically insulating paper described above), surrounds the first interwinding insulation 13. A second interwinding insulation 15 is provided around the first high voltage winding 14 and can be formed from one or more layers of the electrically insulating paper described above. A second low voltage winding 16 (constructed in a similar manner as above) can surround the second interwinding insulation 15. Spacers, tubes, tapes, boards and other conventional transformer components may also be included, as would be understood by one of skill in the art. One or more of these additional transformer components may also be formed from the electrically insulating paper described herein. The entire assembly may be immersed in oil, such as mineral oil, silicone oil, natural or synthetic ester oil, or other conventional transformer fluids.

By utilizing the electrically insulating paper described herein, transformers can be approved for a higher operating class, and can be designed to meet, e.g., IEEE Std. C57.154-2012.

As shown in the examples below, the removal of cellulose and cellulose-based transformer components can lead to much shorter dry out times and enable higher transformer operational temperatures.

### EXAMPLES

The following examples and comparative examples are offered to aid in the understanding of the present invention and are not to be construed as limiting the scope thereof. Unless otherwise indicated, all parts and percentages are by weight. The following test methods and protocols were employed in the evaluation of the illustrative and comparative examples that follow.

### Sample Preparation:

The exemplary electrically insulating nonwoven papers were made using methods known in the art, as follows:

A mixture of 6 wt % microglass (B-04 from Lauscha Fiber International), 64 wt % delaminated kaolin clay (HYDRAPRINT from KaMin, LLC, USA), 13% poly(vinyl alcohol) fiber (fully hydrolyzed, 1.8 denier×6 mm, fiber tenacity of 13 g/denier, from Minifibers Inc, USA), and 17 wt % acrylic latex (HYCAR 26362, Lubrizol Corp) was dispersed in water to form a slurry with a solids content of about 2% by weight. This furnish was then pumped into a cylinder paper machine where the water was drained and the paper was pressed between papermaking wet felt at a pressure of 300 lb/linear inch (54 kg/cm). The paper was then moved into the drying section of the paper maker and dried further to a moisture content of less than about 2% through contact heating with steam heated dryer cans at 250° F. (121° C.). Standard density paper (Example 1) was not calendared after drying, yielding a density of about 50 lb/ft³ (800 kg/m³). High density paper (Example 2) was pressed between steel calendering rolls after drying, yielding a density of about 80 lb/ft³ (1280 kg/m³).

Lab handsheet samples were made by mixing the furnish in a laboratory blender, dewatering through a papermaking screen and press, and drying in a laboratory handsheet dryer.

Comparative example CE1 was a commercially available insulating cellulose-based Kraft paper and was used as received.

### Test Methodologies

| | TEST | |
|---|---|---|
| PROPERTY | METHOD | TITLE |
| Dielectric | ASTM | Standard Test Method for Dielectric |
| Strength | D149-09 | Breakdown Voltage and Dielectric |
| | | Breakdown Strength of Solid Electrical |
| | | Insulating Materials at Commercial |
| | | Power Frequencies |
| Compatibility | ASTM | Standard Test Methods for Compatibility |
| with Insulating | D3455-11 | of Construction Material with Electrical |
| Oil | | Insulating Oil of Petroleum Origin |
| Dielectric | ASTM | Standard Test Methods for AC Loss |
| Loss | D-150-11 | Characteristics and Permittivity |
| | | (Dielectric Constant) of Solid Electrical |
| | | Insulation |
| Dielectric | ASTM | Standard Test Methods for AC Loss |
| Constant | D-150-11 | Characteristics and Permittivity |
| | | (Dielectric Constant) of Solid Electrical |
| | | Insulation |
| Thermal Aging | IEEE | Standard Test Procedure for Thermal |
| Life Curve | C57.100- | Evaluation of Insulation Systems for |
| Testing | 2011 | Liquid-Immersed Distribution and Power |
| | | Transformers |
| MD Tensile | ASTM | Standard Test Method for Tensile |
| Strength | D-828-97 | Properties of Paper and Paperboard Using |
| | (2002) | Constant-Rate-of-Elongation Apparatus |
| CD and MD | Tappi T-414 | Internal Tearing Resistance of Paper |
| Tear Strength | om-04 | (Elmendorf-Type Method) |
| CD and MD | Tappi T-543 | Bending Resistance of Paper |
| Stiffness | | (Gurley-Type Tester) |

Color of the oils after aging with the sample papers was determined by visual inspection. A relative ranking of between 1 and 7 was assigned each sample. A ranking of 1 indicated a light color and 7 indicated that the oil was dark.

Thermal conductivity of the samples was measured using a modified ASTM D5470-06 Heat Flow Meter according to the following procedure. The hot and cold meter bars, 2 in. (5 cm) in diameter and approximately 3 in. (7.6 cm) long, are instrumented with six evenly-spaced thermocouples, the first of which is 5.0 mm away from the interface between the bars. The bars are constructed from brass, with a reference thermal conductivity of 130 W/m-K. The contacting faces of the meter bars are parallel to within about 5 microns, and the force on the sample during testing is approximately 120 N. The thickness of the sample is measured during testing by a digital displacement transducer with a nominal accuracy of 2 microns.

When the meter bars have reached equilibrium, the digital displacement transducer is zeroed. The insulation paper samples were submersed into insulation oil within a glass jar and then deaerated under vacuum in a vacuum oven at room temperature. The oil saturated insulation paper samples were removed from the oil and placed onto the bottom meter bar. The oil served as the interfacial fluid to eliminate thermal contact resistance. The meter bars were closed and the normal force applied. Measurements of the heat flow through the meter bars, and the thickness of the sample are made throughout the duration of the test, typically about 30 minutes. Equilibrium is generally reached within about 10 minutes.

The thermal conductivity of the sample, k, is then calculated from the thickness of the sample (L), the thermal conductivity of the meter bars (kₘ), the temperature gradient in the meter bars (dT/dx), and the extrapolated temperature difference across the sample (Tᵤ-T₁).

$$k = \frac{{k}_{m} ( \frac{d T}{d x} )}{( {T}_{u} - {T}_{1} ) / L}$$

### Results

Table 1 shows that the dielectric strengths of Examples 1 and 2 are similar to the dielectric strength of CE1 in mineral oil, in natural ester vegetable oil (ENVIROTEMP FR3 from Cargill Inc., USA), and in air (no oil).

TABLE 1

| | DIELECTRIC STRENGTH, V/MIL | | |
|---|---|---|---|
| | EXAMPLE 1 | EXAMPLE 2 | CE1 |
| | Standard Density | High Density | Kraft Paper |
| Mineral Oil | 1343 | 1683 | 1450 |
| FR3 Oil | 1384 | 1477 | 1810 |
| No Oil (in Air) | 143 | 227 | 232 |

The insulating paper should also be compatible with the insulating oils and should not substantially reduce the insulating qualities of the oil. Table 2 shows results of dielectric loss measurements and color of the insulating oils after aging with the developmental and comparative papers at 302° F. (150° C.). Insulating paper samples were conditioned in two ways before placing into the oil: one set was dried in a vacuum oven, and the other set was conditioned for 24 hrs in a controlled 23C, 50% RH environment. The jars of oil containing the insulating paper samples were then placed into a vacuum chamber and held at elevated temperature for a few hours in order to infuse the paper with oil. The results show that the conditioning environment of the developmental paper has little effect on the dielectric loss of the insulating oils. However, insulating oils that were aged with the insulating papers of this invention had lower dielectric loss, indicating better electrical insulation performance, in comparison to insulating oils aged with CE1. The color of the insulating oil is another distinguishing characteristic of insulation oil quality. The oils aged with Kraft cellulose paper (CE1) were noticeably darker, which indicates that higher levels of degradation products from the paper are present in the oil.

TABLE 2

| | DIELECTRIC LOSS | | | COLOR | | |
|---|---|---|---|---|---|---|
| | Ex. 1 | Ex. 2 | CE1 | Ex. 1 | Ex. 2 | CE1 |
| FR3 Oil | 1.7% | 3.0% | 5.8% | 5 | 4 | 7 |
| 50% RH FR3 | 2.7% | 2.1% | N/A | 3 | 6 | N/A |
| Oil | | | | | | |
| Mineral Oil | 1.2% | 0.50% | 1.0% | 6 | 6 | 7 |
| 50% RH | 0.55% | 0.37% | N/A | 5 | 2 | N/A |
| Mineral Oil | | | | | | |

Tables 3 and 4 show that the dielectric loss and dielectric constant of the papers of the current invention are similar to CE1 after aging in dry conditions, when measured at ambient and elevated temperature. However, test results after aging in conditions of 23° C. and 50% relative humidity (RH) show that the dielectric properties of Examples 1 and 2 are much less sensitive to ambient moisture content than CE1. The substantially lower water absorption levels of Examples 1 and 2 compared to CE1is also evident from the results shown in Table 5. There was no statistically significant difference between the water absorption levels of the standard density paper (Example 1) and the high density paper (Example 2) and both were considerably lower than the degree of water absorption of CE1.

TABLE 3

| | DIELECTRIC | | | DIELECTRIC | | |
|---|---|---|---|---|---|---|
| | LOSS @ 23° C. | | | LOSS @ 100° C. | | |
| AGING CONDITIONS | Ex. 1 | Ex. 2 | CE1 | Ex. 1 | Ex. 2 | CE1 |
| Unsaturated (No Oil) at | 5.3% | 5.4% | 41% | 7.4% | 8.4% | 60% |
| 23° C./50% RH | | | | | | |
| Unsaturated (No Oil) in | 2.9% | 3.1% | 1.0% | 7.8% | 8.8% | 6.6% |
| Dry Vacuum Oven | | | | | | |
| Saturated in Mineral Oil in | 1.5% | 1.9% | 0.96% | 11% | 13% | 9.3% |
| Dry Vacuum Oven | | | | | | |
| Saturated in FR3 Oil in Dry | 1.7% | 2.2% | 1.0% | 12% | 13% | 9.3% |
| Vacuum Oven | | | | | | |

TABLE 4

| | DIELECTRIC | | | DIELECTRIC | | |
|---|---|---|---|---|---|---|
| | CONSTANT | | | CONSTANT | | |
| | @ 23° C. | | | @ 100° C. | | |
| AGING CONDITIONS | Ex. 1 | Ex. 2 | CE1 | Ex. 1 | Ex. 2 | CE1 |
| Unsaturated (No Oil) at | 1.80 | 2.78 | 4.85 | 2.16 | 3.54 | 4.93 |
| 23° C./50% RH | | | | | | |
| Unsaturated (No Oil) in Dry | 1.91 | 2.88 | 2.42 | 2.34 | 3.67 | 2.91 |
| Vacuum Oven | | | | | | |
| Saturated in Mineral Oil in | 2.78 | 3.55 | 3.31 | 3.95 | 4.88 | 4.28 |
| Dry Vacuum Oven | | | | | | |
| Saturated in FR3 Oil in Dry | 3.35 | 3.87 | 3.89 | 4.5 | 5.34 | 4.58 |
| Vacuum Oven | | | | | | |

TABLE 5

| | WATER CONTENT | | |
|---|---|---|---|
| | Ex. 1 | Ex. 2 | CE1 |
| 50% RH | 0.90% | 0.90% | 6.4% |
| 65% RH | 1.0% | 1.0% | 7.0% |
| 95% RH | 3.7% | 3.7% | 27% |

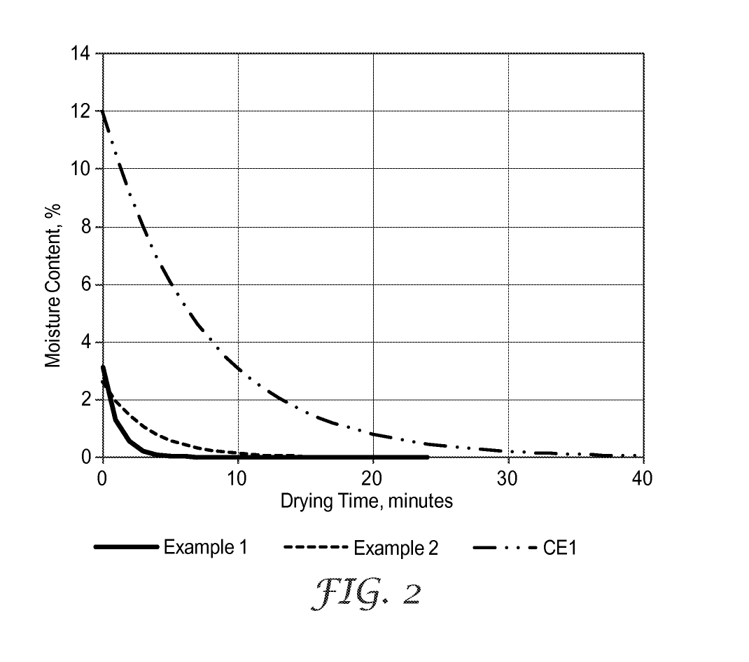

To demonstrate the rate at which moisture present in the insulating paper can be removed, stacks of insulating papers approximately 95 mils (2.4 mm) thick were first conditioned at 95% RH for 20 hours and then dried at a temperature of either 115° C. or 150° C. The results provided in Table 6 demonstrate that the moisture in the inventive examples is removed more quickly in comparison to CE1. The results for the trial at 150° C. are also illustrated graphically in FIG. 2.

TABLE 6

| | WATER CONTENT | | | WATER CONTENT | | |
|---|---|---|---|---|---|---|
| | (% MOISTURE) DRYING | | | (% MOISTURE) DRYING | | |
| | TEMPERATURE = | | | TEMPERATURE = | | |
| Drying | 115° C. | | | 150° C. | | |
| Time, min. | Ex. 1 | Ex. 2 | CE1 | Ex. 1 | Ex. 2 | CE1 |
| 0 | 2.4% | 2.3% | 12% | 3.1% | 2.6% | 12% |
| 1 | 1.8% | 2.0% | 11% | 1.3% | 1.9% | 10% |
| 2 | 1.4% | 1.7% | 10% | 0.54% | 1.4% | 9.1% |
| 3 | 1.0% | 1.5% | 9.2% | 0.23% | 1.1% | 8.0% |
| 4 | 0.76% | 1.3% | 8.5% | 0.09% | 0.78% | 7.0% |
| 5 | 0.57% | 1.1% | 7.9% | 0.04% | 0.58% | 6.1% |
| 6 | 0.42% | 0.97% | 7.3% | 0.02% | 0.43% | 5.3% |
| 7 | 0.32% | 0.84% | 6.7% | 0.01% | 0.32% | 4.6% |
| 8 | 0.24% | 0.72% | 6.2% | 0% | 0.23% | 4.0% |
| 10 | 0.13% | 0.54% | 5.3% | 0% | 0.13% | 3.1% |
| 12 | 0.08% | 0.41% | 4.5% | | 0.07% | 2.4% |
| 14 | 0.04% | 0.30% | 3.9% | | 0.04% | 1.8% |
| 16 | 0.02% | 0.23% | 3.3% | | 0.02% | 1.4% |
| 18 | 0.01% | 0.17% | 2.8% | | 0.01% | 1.0% |
| 20 | 0.01% | 0.13% | 2.4% | | 0.01% | 0.79% |
| 24 | 0.0% | 0.07% | 1.8% | | 0% | 0.46% |
| 30 | | 0.03% | 1.1% | | | 0.20% |
| 35 | | | 0.74% | | | 0.10% |
| 40 | | | 0.40% | | | 0.05% |
| 45 | | | 0.34% | | | |
| 50 | | | 0.23% | | | |
| 55 | | | 0.15% | | | |
| 60 | | | 0.10% | | | |

Results from Thermal Aging Life Curve testing are provided in Table 7. Example 1 shows excellent retained tensile strength (97%) after aging at 190° C. for 700 hours in mineral oil. In comparison, CE1, after aging in mineral oil at 180° C., has already reached 0% retained tensile strength at 500 hours aging time and 50% retained tensile strength at 235 hours of aging time. (Note that the end of life test value is typically considered to be the time at which 50% retained tensile strength is reached.) The much higher retained tensile strength of the exemplary cellulose-free electrically insulating papers in comparison to CE1 indicates the potential for the insulating papers of this invention to function at higher transformer operational temperatures.

TABLE 7

| | RETAINED TENSILE STRENGTH | | | |
|---|---|---|---|---|
| Aging Time, | Ex. 1 | Ex. 1 | CE1 | CE1 |
| hours | @ 190° C. | @ 205° C. | @160° C. | @180° C. |
| 0 | 100% | 100% | 100% | 100% |
| 97 | | | | 75% |
| 201 | | | | 53% |
| 297 | | | | 42% |
| 552 | | 56% | 67% | |
| 672 | | 49% | 59% | |
| 697 | 97% | | | |
| 864 | | | 48% | |

The mechanical properties of the illustrative and comparison examples are summarized in Table 8. The tear strength of Examples 1 and 2 in both machine direction (MD) and cross direction (CD) appears to be comparable to CE1. Although the tensile strengths of Examples 1 and 2 are not as high as CE1, a coil winding trial by a transformer manufacturer indicated that the tensile strength of the inventive papers is sufficient to withstand the transformer manufacturing process. The transformer unit made with Example 1 passed standard quality control tests requirements. In addition, resistance measurements performed before and after drying the transformer unit made with Example 1 indicated that the drying step may be eliminated.

Thermal conductivity results (also provided in Table 8) show that Examples 1 and 2 both demonstrate a higher thermal conductivity than CE1 when saturated in mineral oil.

TABLE 8

| | Ex. 1 | Ex. 2 | CE1 |
|---|---|---|---|
| MD Tensile Strength, | 30 (5.3) | 33 (5.8) | 80 (14) |
| lb/in (N/mm) | | | |
| MD Tear Strength, g | 248 | 172 | 168 |
| CD Tear Strength, g | 358 | 281 | 240 |
| MD Stiffness, mg | 1032 | 534 | 1313 |
| CD Stiffness, mg | 652 | 304 | 307 |
| Thermal Conductivity | 0.261 | 0.333 | 0.24 |
| in Mineral Oil, W/m-K | | | |

Testing by an independent test laboratory has verified that both Examples 1 and 2 meet or exceed the oil compatibility requirements detailed in ASTM D3455-11, “Standard Test Methods for Compatibility of Construction Material with Electrical Insulating Oil of Petroleum Origin.”

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. This application is intended to cover any adaptations or variations of the preferred embodiments discussed herein. Therefore, it is manifestly intended that this invention be limited only by the claims and the equivalents thereof.

1. An article comprising:
an inorganic filler;
fully hydrolyzed polyvinyl alcohol fibers;
a polymer binder; and
high surface area fibers.

2. The article of claim 1 formed as a nonwoven paper.

3. The article of claim 1 wherein the inorganic filler comprises at least one of kaolin clay, talc, mica, calcium carbonate, silica, alumina, alumina trihydrate, montmorillonite, smectite, bentonite, illite, chlorite, sepiolite, attapulgite, halloysite, vermiculite, laponite, rectorite, perlite, aluminum nitride, silicon carbide, boron nitride, and combinations thereof.

4. The article of claim 3 wherein inorganic filler comprises kaolin clay.

5. The article of claim 4 wherein the kaolin clay comprises at least one of water-washed kaolin clay, delaminated kaolin clay, calcined kaolin clay, and surface-treated kaolin clay.

6. The article of claim 1, wherein the polymer binder comprises a latex-based material.

7. The article of claim 1, wherein the polymer binder comprises at least one of acrylic, nitrile, and styrene acrylic latex.

8. The article of claim 1, wherein the high surface area fibers comprise glass microfiber.

9. The article of claim 1 comprising from about 3% to about 20% fully hydrolyzed polyvinyl alcohol fibers, wherein the percentages are by weight.

10. The article of claim 9, comprising:
from about 50% to about 85% kaolin clay;
from about 7% to about 25% polymer binder; and
from about 2% to about 10% glass microfiber, wherein the percentages are by weight.

11. The article of claim 1, wherein the article is substantially cellulose free.

12. The article of claim 1 wherein the article is non-hygroscopic.

13. An insulation system for electrical equipment, wherein the insulation system comprises the article of claim 1.

14. The insulation system of claim 13, wherein the electrical equipment comprises one of a transformer, a motor, and a generator.

15. The insulation system of claim 13, wherein the electrical equipment comprises a liquid filled transformer.

16. An oil filled transformer comprising electrically insulating paper having fully hydrolyzed polyvinyl alcohol fibers.

17. The oil filled transformer of claim 16, wherein the electrically insulating paper further comprises an inorganic filler, a polymer binder, and glass microfibers.

18. The oil filled transformer of claim 17, wherein the electrically insulating paper further comprises about 3% to about 20% fully hydrolyzed polyvinyl alcohol fibers, from about 50% to about 85% kaolin clay, from about 7% to about 25% polymer binder, and from about 2% to about 10% glass microfiber, wherein the percentages are by weight.

19. The oil filled transformer of claim 16, wherein the electrically insulating paper is substantially cellulose free.
